(19) United States
(12) Patent Application Publication
(10) Pub. No.: US 2010/0285308 A1
(43) Pub. Date: Nov. 11, 2010

(54) Composite Articles Having Excellent Adhesion Strength And Methods Of Forming The Same

(76) Inventors: William H. Merritt, Ferndale, MI (US); Gregory G. Menovcik, Northville, MI (US)

Correspondence Address: HOWARD & HOWARD ATTORNEYS PLLC;BASF CORPORATION, 450 West Fourth Street, Royal Oak, MI, 48067, US

(21) Appl. No.: 12/740,519

(22) PCT Filed: Oct. 29, 2008
(86) PCT No.: PCT/US08/12252

§ 371 Date: Jul. 28, 2010

(30) Foreign Application Priority Data
Oct. 29, 2007 (US) 60983480

(51) Int. Cl. B32B 15/08; B32B 37/00

(52) U.S. Cl. 428/335; 156/60; 428/423.1; 428/458; 428/457; 428/336

(57) ABSTRACT

A composite article generally comprises a substantially transparent outermost layer, a tie-layer, and a backing layer. The composite article can also include a substrate layer. The tie-layer imparts excellent adhesion strength between the substantially transparent outermost layer and the backing layer. The outermost layer is formed from a coating composition, e.g. a clearcoat paint composition, and can optionally be tinted. The tie-layer is formed from an adhesion promoting composition comprising a halogenated polyolefin, such as chlorinated polyolefin (CPO), and optionally, a solvent, such as an organic solvent. The backing layer is formed from a metal composition, such as chrome. If employed, the substrate layer is typically formed from a plastic, such as acrylonitrile butadiene styrene. The composite articles of the present invention may be used for various applications, such as for automobile parts and trim. The composite article can have an imparted aesthetic effect, such as being pewter in color.

### CROSS REFERENCE TO RELATED APPLICATIONS

This application claims the benefit of U.S. Provisional Patent Application Ser. No. 60/983,480, filed on Oct. 29, 2007, the disclosure of which is incorporated herewith in its entirety by reference.

### FIELD OF THE INVENTION

The present invention generally relates to a composite article and, more specifically, to a composite article comprising a tie-layer formed from an adhesion promoting composition comprising a halogenated polyolefin and to a method of forming the composite article.

### DESCRIPTION OF THE RELATED ART

Composite articles, such as metal-plated plastics, are well known in the art. For example, chrome-plated plastic, such as chrome-plated acrylonitrile butadiene styrene (ABS), is often used as parts and trim for automobiles, such as for automobile grilles, window trim, light trim, etc.

Originally, chrome-plated plastic was intended to be a finished composite article in its own right, with a highly reflective, mirror-like surface. The highly reflective, mirror-like surface is typically treated to make the surface very non-polar, i.e., non-reactive, to reduce degradation of the surface, and therefore, to reduce degradation of the finished composite article. In other words, the chrome-plated plastic was not originally designed or intended to be a substrate with a subsequent coating applied thereto, such as a coating of a paint composition over the surface.

Recently, it has been desirable to coat the chrome-plated plastic with paint compositions, such as clearcoats and tinted clearcoats to impart the chrome-plated plastics (e.g. substrates), with various colors, such as those having a pewter appearance, due to, among other things, contrast between the chrome and the tinted clearcoat. Conventional paint compositions employed for coating the chrome-plated plastics are reactive (e.g. polar). Unfortunately, due to the differences in polarity between the paint compositions (generally polar) and the surface of the chrome-plated plastic (generally non-polar), conventional paint compositions have provided inadequate adhesion strength for advanced humidity and thermal shock testing and performance, such as GM4465P and GM9525P test standards. Specifically, chrome-plated plastics that have clearcoats disposed thereon have shown adhesion failure after exposure to the elements, especially in Northern climates, such as in Canada and in the northern United States. Adhesion failure between the clearcoat and the chrome-plated plastic is accelerated if the clearcoat is penetrated, such as by scratches or chips (e.g. stone chips). Exposure to moisture, such as rain or even water from carwashes, and changes in temperature, known as “thermal shock”, further accelerates adhesion failure of the clearcoat. Generally, the clearcoat is weatherproof until the surface is penetrated and the chrome-plated plastic is exposed underneath. After such penetration, the clearcoat progressively peels off due to adhesion failure between the clearcoat and the chrome-plated plastic.

Attempts have been made to adjust conventional paint compositions to try to remedy the adhesion failure problems described above. However, these adjustments to conventional paint compositions either increase initial adhesion strength and decrease humidity resistance, or increase humidity resistance and decrease initial adhesion strength of the clearcoat relative to the chrome-plated plastic. Alternatively, or in addition to adjusting conventional paint compositions, the chrome-plated plastic is often surface treated, such as by applying a flame treatment to a surface of the chrome-plated plastic, to temporarily adjust polarity of the surface of the chrome-plated plastic to better match that of the conventional paint compositions. However, such surface treatment is time consuming, expensive, and temporal, since such surface treatment only lasts for one or two days maximum, which necessitates application of the conventional paint compositions to the surface as soon as possible.

Accordingly, there remains an opportunity provide improved composite articles and methods of making such improved composite articles.

### SUMMARY OF THE INVENTION AND ADVANTAGES

The present invention provides a composite article. The composite article comprises a substantially transparent outermost layer formed from a clearcoat composition. The composite article further comprises a backing layer disposed adjacent the substantially transparent outermost layer. The backing layer is formed from a metallic composition for imparting the composite article with an aesthetic effect. The composite article yet further comprises a tie-layer. The tie-layer is disposed between the substantially transparent outermost layer and the backing layer for adhering the substantially transparent outermost layer and the backing layer. The tie-layer is formed from an adhesion promoting composition comprising a halogenated polyolefin. The present invention further provides a method of forming the composite article.

The composite article of the present invention comprises a unique combination of the aforementioned layers. The tie-layer generally imparts the composite article with excellent adhesion, humidity, and thermal shock performance.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a plurality of composite articles of the present invention attached to a car;

FIG. 2 is an exploded cross-sectional view of an embodiment of a composite article according to the present invention;

FIG. 2A is a cross-sectional view of the composite article depicted in FIG. 2;

FIG. 3 is a cross-sectional view of another embodiment of the composite article according to the present invention;

FIG. 4 is an exploded cross-sectional view of another embodiment of a composite article according to the present invention; and

FIG. 4A is a cross-sectional view of the composite article depicted in FIG. 4.

### DETAILED DESCRIPTION OF THE INVENTION

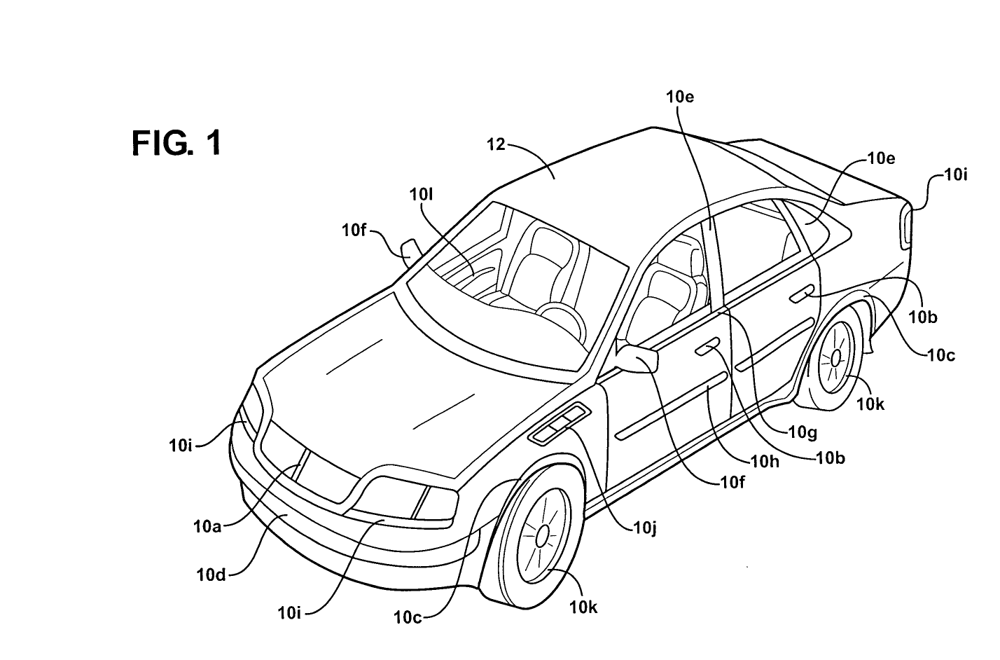

Referring to the Figures, wherein like numerals indicate like parts throughout the several views, a composite article is shown generally at 10. In one embodiment, as shown in FIG. 1, a car 12 includes a plurality of composite articles 10, which are configured as exterior part and trim components, more specifically, as a grill 10a, door handles 10b, fender trim 10c, bumper trim 10d, pillar and post trim 10e, side-mirror trim 10f, window trim 10g, side-molding trim 10h, light trim 10i, vent trim 10j, and wheel trim 10k. It is to be appreciated that the composite article 10 may be used for other exterior part and trim components (e.g. rocker-panel trim), and can be used for interior part and trim components, such as pedal trim, shifter trim, dashboard trim, door-panel trim 10l, etc. While the composite articles 10 are shown as automobile part and trim components for the car 12, it is to be appreciated that the composite article 10 may be used for other vehicles, such as trucks, SUVs, boats, snowmobiles, ATVs, jet-skis, planes, motorcycles, bikes, etc. The composite article 10 may also be used for other applications besides automotive applications, such as fascia and/or trim for furniture, building components (e.g. faucets, knobs, handles, etc.), toys, computers, and appliances (e.g. washers, dryers, vacuums, mixers, etc.). It is to be appreciated that the present invention is not limited to any particular use of the composite article 10.

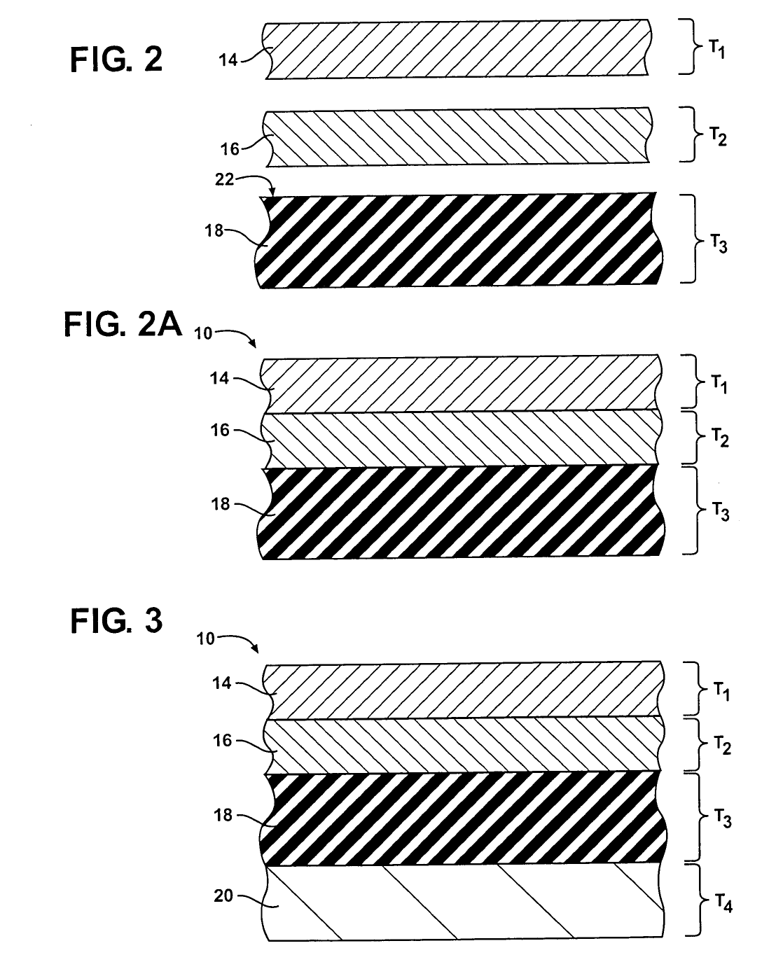

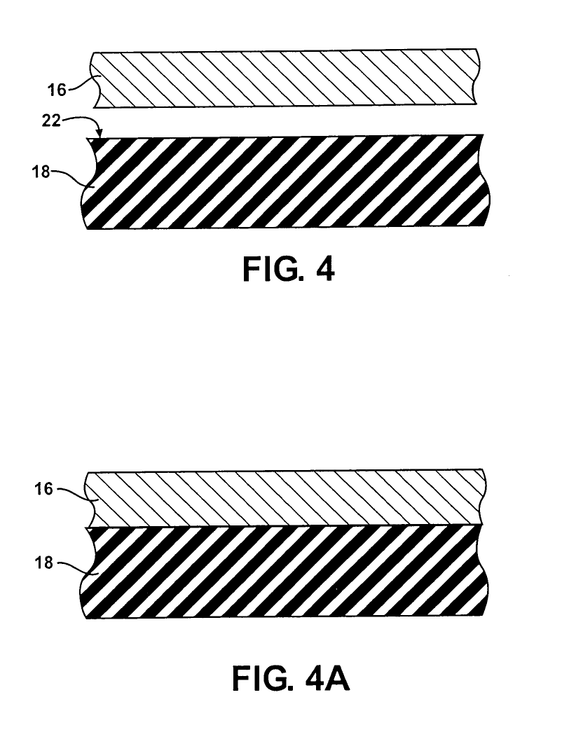

In certain embodiments, the composite article 10, hereinafter, the article 10, comprises a substantially transparent outermost layer 14, a tie-layer 16, and a backing layer 18. The backing layer 18 is disposed adjacent the substantially transparent outermost layer 14. The tie-layer 16 is disposed between the substantially transparent outermost layer 14 and the backing layer 18 for adhering the substantially transparent outermost layer 14 and the backing layer 18. As best shown in FIGS. 2 and 2A, the tie-layer 16 is disposed on and in direct contact with the backing layer 18, and the substantially transparent outermost layer 14 is disposed on and in direct contact with the tie-layer 16. In one embodiment, as shown in FIG. 3, the backing layer 18 of the article 10 is disposed on and in direct contact with a substrate layer 20. In a separate embodiment, as best shown in FIGS. 4 and 4A, the article 10 lacks the outermost layer 14 such that the article 10 comprises the tie-layer 16 (as an outermost layer) overlaying and in direct contact with the backing layer 18. In this embodiment, the article 10 can also include the substrate layer 20, as introduced above, such that the tie-layer 16 would be disposed on and in direct contact with the substrate layer 20 (not shown). With reference to the aforementioned figures, it can be appreciated that the article 10 does not generally have intervening layers disposed between the substantially transparent outermost layer 14, tie-layer 16, backing layer 18, and/or substrate layer 20. Further description of the layers 14, 16, 18, 20 for each of the aforementioned embodiments is provided below.

If employed, the substantially transparent outermost layer 14, hereinafter, the outermost layer 14, generally protects the layers disposed underneath, such as the backing layer 18, the substrate layer 20, etc. By “substantially transparent”, it is meant that the outermost layer 14 has little to no hiding power, as understood in the coatings art. For example, the outermost layer 14 typically permits greater than 50%, more typically greater than 75%, yet more typically greater than 90%, and most typically greater than 95%, transmission of light through the outermost layer 14 to the tie- and backing layers 16, 18. Transmission of light can be determined by various methods known in the art, such as a modified (reversed) hiding power test method. The outermost layer 14 also generally imparts the article 10 with an aesthetic effect, e.g. a color of the article 10. In certain embodiments, the outermost layer 14 can be clear or slightly tinted with various amounts of a colorant, such as a dye or pigment (e.g. carbon black pigment). For example, in one embodiment described in further detail below, the backing layer 18 comprises chromium and is therefore chrome in color and the outermost layer 14 is tinted with an amount of carbon black sufficient to impart the article 10 with a pewter or smoky color, due to the combination of the chrome and tinting. It is to be appreciated that various portions of the outermost layer 14 may be different than one another. For example, the outermost layer 14 can include a transparent portion and a tinted portion, gradients of tinting, etc.

As alluded to above, the outermost layer 14 is formed from a coating composition, typically a clearcoat composition. The clearcoat composition may be any clearcoat coating composition known in the coatings art, such as a clearcoat paint composition or a clearcoat ink composition. Typically, the clearcoat composition is a clearcoat paint composition, which may be a waterborne paint composition or a solventborne paint composition. The clearcoat paint composition can be formulated as either a one-component (one-package or 1K) or a two-component (two-package or 2K) paint composition, as understood in the coatings art. The clearcoat paint composition may be selected from the group of, but is not limited to, acrylic paint compositions, urethane paint compositions, urethane/acrylic paint compositions, carbamate paint compositions, melamine paint compositions, polyester paint compositions, and combinations thereof. In certain embodiments, the clearcoat composition is a urethane/acrylic paint composition. In certain embodiments, the paint composition is classified as a reactive coating system (due to, for example, being polar), as understood by those skilled in the coatings art. Typically, the clearcoat paint composition is polar, such that the outermost layer 14 is also polar once formed. The outermost layer 14 is generally classified as being flexible, as understood in the coatings art. Typically, the outermost layer 14 is at least as flexible as layers beneath it (e.g. the substrate layer 20), to prevent cracking and/or distortion of the outermost layer 14.

In one embodiment, the outermost layer 14 is a clearcoat formed from a solventborne 2K urethane/acrylic paint composition. As shown in FIGS. 2 through 3, the outermost layer 14 is formed from one coating composition, e.g. a clearcoat composition. However, it is to be appreciated that if the outermost layer 14 comprises two or more sub-layers (not shown), the sub-layers may be oriented in various orders, such as a substantially transparent clearcoat disposed over a tinted clearcoat, or vice versa.

Suitable clearcoat paint compositions, for purposes of the present invention, are commercially available from BASF Corporation of Florham Park, N.J., under the trade names STAINGUARD®, URECLEAR®, DURACLEAR®, and INOVA®. Other suitable paint compositions are commercially available from Red Spot Paint & Varnish Company, of Evansville, Ind. Yet other suitable paint compositions are disclosed by U.S. Pat. No. 5,137,972 to Cook; U.S. Pat. No. 4,720,528 to Etzell et al.; U.S. Pat. No. 5,216,078 to Cook et al.; U.S. Pat. No. 5,238,999 to Cook et al.; U.S. Pat. No. 5,276,096 to Serdiuk et al.; U.S. Pat. No. 5,356,669 to Rehfuss et al.; U.S. Pat. No. 5,379,947 to Williams et al.; U.S. Pat. No. 5,494,970 to Serdiuk; U.S. Pat. No. 5,498,783 to Foukes et al.; U.S. Pat. No. 5,559,195 to McGee et al.; U.S. Pat. No. 5,596,043 to Harris et al.; U.S. Pat. No. 5,635,302 to Budde et al.; U.S. Pat. No. 6,995,208 to Mehta et al.; U.S. Pat. No. 6,071,568 to Harmon et al.; U.S. Pat. No. 5,605,965 to Rehfuss et al.; U.S. Pat. No. 5,474,811 to Rehfuss et al.; and U.S. Pat. No. 5,726,246 to Rehfuss et al.; the disclosures of which are incorporated herewith by reference in their entirety. It is to be appreciated that the outermost layer 14 may be formed from any combination of two or more of the aforementioned clearcoat paint compositions.

If employed in the outermost layer 14 for tinting the outermost layer 14, the colorant may be any type of colorant known in the coatings art, such as a powdered pigment, a pigment dispersion, a color concentrate, a masterbatch, etc. Suitable colorants, for purposes of the present invention, are commercially available from a variety of suppliers. If employed, the colorant is typically present in an amount of from about 0.001 to about one (1), more typically from about 0.01 to about 0.5, yet more typically from about 0.01 to about 0.1, and most typically about 0.01, parts by weight, based on 100 parts by weight of the clearcoat coating composition. Typically, higher amounts of the colorant impart more tinting, while lower amounts impart less tinting

The tie-layer 16, which may also be referred to in the coatings art as a primer layer 16, is useful for protecting the layers disposed underneath (e.g. the backing layer 18, the substrate layer 20, etc). It is to be appreciated that the tie-layer 16 can also be referred to as an outermost layer of the article 10 when the outermost layer 14 is not employed. Typically, the tie-layer 16 is substantially transparent. By “substantially transparent”, it is meant that the tie-layer 16 has little to no hiding power, as understood in the coatings art. For example, the tie-layer 16 typically permits greater than 50%, more typically greater than 75%, yet more typically greater than 90%, and most typically greater than 95%, transmission of light through the tie-layer 16 to the backing layer 18. Alternatively, but not typically, the tie-layer 16 may have a color or be tinted, such as described and exemplified above with description of the outermost layer 14. The tie-layer 16 is especially useful for imparting excellent adhesion strength between the outermost layer 14 (if employed) and the backing layer 18. The tie-layer 16 is especially useful for providing improved adhesion between the outermost layer 14 to the backing layer 18 when exposed to environmental conditions such as those conditions that occur during advanced humidity and thermal-shock-type testing, as understood by those skilled in the coatings art, and as described and exemplified in the EXAMPLES section below. If the tie-layer 16 is the outermost layer of the article 10, the tie-layer 16 provides protection for the backing layer 18.

The tie-layer 16 can also impart the article 10 with improved appearance, increased exterior durability (e.g. excellent thermal shock resistance, increased weatherability resistance, increased humidity resistance, and increased chemical resistance), and excellent scratch and mar resistance. In certain embodiments, the tie-layer 16 may partially react (and/or interact) with the outermost layer 14 and/or the backing layer 18 to further increase adhesion strength between the outermost and backing layers 14, 18. Without being bound or limited by any particular theory, it is believed that a degree of ionic interaction between the tie-layer 16 and the backing layer 18 can occur. Further, it is believed that tie-layer 16 is generally not penetrated (or dissolved) by the outermost layer 14, when employed.

The tie-layer 16 is formed from an adhesion promoting composition. The adhesion promoting composition comprises a halogenated polyolefin. Examples of suitable halogenated polyolefins, for purposes of the present invention, include fluorinated polyolefins, chlorinated polyolefins, brominated polyolefins, iodinated polyolefins, etc., and combinations thereof. Typically, the halogenated polyolefin is a chlorinated polyolefin (CPO). Various types and grades of CPO may be used to form the tie-layer 16. Halogenated polyolefins, particularly, CPUs, along with methods for their preparation, are disclosed in U.S. Pat. No. 5,319,032 to Martz et al.; U.S. Pat. No. 5,840,783 to Momchilovich et al.; U.S. Pat. Nos. 5,385,979; 5,198,485 to Ozawa et al.; U.S. Pat. No. 5,863,646 to Verardi et al.; U.s. Pat. No. 5,489,650 to Ainsworth et al.; and U.S. Pat. No. 4,273,894 to Mucke et al.; the disclosures of which are incorporated herewith in their entirety. In certain embodiments, the adhesion promoting composition consists essentially of the halogenated polyolefin, e.g. CPO.

The halogenated polyolefin may have various amounts of halogen content as understood by those skilled in the art. Typically, the halogenated polyolefin has a halogen content of from about one (1) to about 50, more typically from about five (5) to about 35, and most typically from about 10 to about 30, percent halogen, based on the total weight of the halogenated polyolefin. In certain embodiments employing CPO, the CPO typically has a chlorine content of from about three (3) to about 35, more typically from about 15 to about 30, and most typically from about 20 to about 25, percent chlorine, based on the total weight of the CPO. In one embodiment employing CPO, the CPO has a chlorine content of about 20 percent based on the total weight of the CPO. It is believed that the amount of halogen employed in the halogenated polyolefin may be useful for varying polarity of the tie-layer 16. Typically, the tie-layer 16 is classified as being non-polar to very non-polar. The tie-layer 16 imparts excellent adhesion strength between the outermost and backing layers 14, 18 when the outermost and backing layers 14, 18 are of different polarity, such as when the outermost layer 14 is polar and the backing layer 18 is non-polar. Without being bound or limited by any particular theory, it is believed that length and/or shape of CPO molecules present in the tie-layer 16 can provide physical anchoring for the outermost layer 14 thereby increasing adhesion strength between the tie-layer 16 and the outermost layer 14.

In certain embodiments, the halogenated polyolefin is modified with maleic anhydride. For example, in certain embodiments employing CPO, the CPO is modified with maleic anhydride. The halogenated polyolefin may be modified by other modifiers or additives known in the art, such as an acrylic resin, [4-[(1,1-dimethylethyl)phenoxy]methyl]oxirane, etc. It is to be appreciated that the adhesion promoting composition may include other additives known in the coatings art, such as crosslinkers and/or other adhesion promoters known in the coatings art. If employed, the maleic anhydride may be employed in various amounts, typically in an amount of from about one (1) to about 10, more typically from about one (1) to about five (5), most typically from about two (2) to about three (3), percent maleic anhydride, based on the total weight of the halogenated polyolefin, e.g. CPO. It is believed that the maleic anhydride is useful for imparting some amount of polarity to the halogenated polyolefin, or to portions thereof, and therefore to portions of the tie-layer 16, which can further impart adhesion strength between the outermost layer 14 and the backing layer 18. It is also believed that the maleic anhydride may at least partially react with at least the outermost layer 14 to increase adhesion strength between the outermost and backing layers 14, 18. Without being bound or limited by any particular theory, it is also believed that electron clouds/density, and arrangements thereof, imparted by the halogenated polyolefin and/or maleic anhydride increases adhesion strength imparted by the tie-layer 16.

The halogenated polyolefin, e.g. CPO, may be of various molecular weights. In certain embodiments, the halogenated polyolefin has a number average molecular weight of at least about 50,000, alternatively at least about 60,000, alternatively at least about 75,000. It is to be appreciated that the halogenated polyolefin may have lower number average molecular weights. As alluded to above, it is believed that length and size of halogenated polyolefin molecules can provide physical anchoring.

In certain embodiments, the adhesion promoting composition further comprises a solvent in addition to the halogenated polyolefin. The solvent is generally used to dissolve and/or carry the halogenated polyolefin (if in a solid form) or thin the halogenated polyolefin (if in a liquid or an emulsion form). In one embodiment, the solvent is an organic solvent. The solvent can comprise non-polar and polar solvents, such as toluene, xylene, benzene, diethyl ether, ethyl acetate, Aromatic 100, chloroform, methyl ethyl ketone (MEK), methyl isobutyl ketone, isopropyl alcohol (IPA), ethanol, methanol, acetone, tetrahydrofuran (THF), SC-100, SC-150, butyl cellosolve, etc. It is to be appreciated that the adhesion promoting composition may include a combination of two or more of the aforementioned solvents. In other embodiments, the adhesion promoting composition further comprises water, if the halogenated polyolefin can be dissolved or thinned by water.

The halogenated polyolefin may be present in the adhesion promoting composition in various amounts. Typically, the halogenated polyolefin is present in an amount of from about five (5) to about 50, more typically from about 10 to about 30, yet typically from about 10 to about 20, and most typically about 15, parts by weight, based on 100 parts by weight of the adhesion promoting composition including the solvent. In certain embodiments, the halogenated polyolefin comprises CPO, and is present in an amount of about 15 parts by weight based on 100 parts by weight of the adhesion promoting composition including the solvent, e.g. Aromatic 100. In the aforementioned embodiments, the solvent may comprise the remaining parts by weight of the adhesion promoting composition, i.e., about 85 parts by weight. For example, the solvent can comprise Aromatic 100 and butyl cellosolve, such that the adhesion promoting composition comprises about 15 parts by weight maleic anhydride modified CPO, about 83 parts by weight Aromatic 100, and about 2 parts by weight butyl cellosolve, each based on 100 parts by weight of the adhesion promoting composition.

To form the adhesion promoting composition including the solvent, the solvent is typically provided in a vessel, and the halogenated polyolefin is cut into the solvent(s) with a mixer to form the adhesion promoting composition, especially if the halogenated polyolefin is a solid, such as a powder, pellets, etc. It is to be appreciated that in certain embodiments, the adhesion promoting composition comprises about 100 parts by weight of the halogenated polyolefin, i.e., the adhesion promoting composition can consist of the halogenated polyolefin.

Suitable adhesion promoting compositions and/or halogenated polyolefins, for purposes of the present invention, are commercially available from Toyo Kasei Kogyo Co., Ltd., of Osaka, Japan, under the trade name HARDLEN®, including, but not limited to, the following HARDLEN® grades (including 100% solids, solventborne, and waterborne halogenated polyolefins): 13-LP, 13-LLP, 14-LWP, 14-WL-P, 15-LP, 15-LLP, 16-LP, DX-525P, CY-9122P, CY-9124-P, HM-21P, M-28P, F-2P, F-6P, F-7P, CY-1132, EH-801, EW-5303, EW-5504, EW-5313, EW-8511, EZ-1000, EZ-2000, P-5528, EY-4052, EY-4075, EY-4011, EY-6011, and combinations thereof. In certain embodiments, the adhesion promoting composition comprises HARDLEN® F-2P, and some of these embodiments further comprise the solvent. In one embodiment, the adhesion promoting composition comprises about 15 parts by weight of HARDLEN® F-2P with the remaining parts by weight being a blend of Aromatic 100 and butyl cellosolve as the solvent.

Other suitable adhesion promoting compositions and/or halogenated polyolefins, for purposes of the present invention, are commercially available from Eastman Chemical Company of Kingsport, Tenn. These adhesion promoting compositions include, but are not limited to, 100% solids, solventborne, and waterborne adhesion promoting compositions, such as Eastman Chlorinated Polyolefin 153-2 (25% solids in xylene); Eastman Chlorinated Polyolefin 164-1 (100% solids); Eastman Chlorinated Polyolefin 343-1 (100% solids); Eastman Chlorinated Polyolefin 343-1 (25% solids in xylene); Eastman Chlorinated Polyolefin 343-1 (40% solids in xylene); Eastman Chlorinated Polyolefin 343-1 (50% solids in xylene); Eastman Chlorinated Polyolefin 343-3 (25% solids in xylene); Eastman Chlorinated Polyolefin 343-3 (50% solids in xylene); Eastman Chlorinated Polyolefin 515-2 (40% solids in Aromatic 100); Eastman Chlorinated Polyolefin 515-2 (40% solids in toluene); Eastman Chlorinated Polyolefin 515-2 (40% solids in xylene); Eastman Modified Chlorinated Polyolefin CP-164-1 (25% solids in xylene); Eastman CP 310W Waterborne Chlorinated Polyolefin Adhesion Promoter; Eastman CP 347W Waterborne Chlorinated Polyolefin Adhesion Promoter; Eastman CP 349W Waterborne Chlorinated Polyolefin Adhesion Promoter; Eastman CP 730-1 Chlorinated Adhesion Promoter (100% solids); Eastman CP 730-1 Chlorinated Adhesion Promoter (20% solids in Aromatic 100); Eastman CP 730-1 Chlorinated Adhesion Promoter (20% solids in xylene); and combinations thereof.

Yet other suitable adhesion promoting compositions, for purposes of the present invention, are commercially available from Nippon Paper Chemicals Co., Ltd., of Tokyo, Japan, under the trade names SUPERCHLON® and AUROREN®, including, but are not limited to, SUPERCHLON® E-723, E-673, and E-503; and AUROREN® 100, 150, and 200. It is to be appreciated that the adhesion promoting compositions may comprise two or more of the aforementioned adhesion promoting compositions and/or halogenated polyolefins. It is also to be appreciated that the commercially available adhesion promoting compositions may be used alone as the adhesion promoting composition described and exemplified above, or may have water or the solvent added thereto to form the adhesion promoting composition, as previously described.

In certain embodiments, the coating composition, as described and exemplified above with description of the outermost layer 14, includes the adhesion promoting composition as an additive. It is believed that using the adhesion promoting composition as the additive in the coating composition may further impart adhesion strength between the outermost layer 14 and the backing layer 18 via the tie-layer 16. If employed as the additive, the adhesion promoting composition may be used in the coating composition in various amounts, such as in amount of about 50 parts by weight or more. If employed as the additive, the adhesion promoting composition is typically present in the coating composition in an amount of at least about 50, alternatively of from about one (1) to about 50, more typically from about one (1) to about 25, yet more typically from about one (1) to about 10, and most typically from about one (1) to about five (5), parts by weight, based on 100 parts by weight of the coating composition.

The backing layer 18 is formed from a metallic composition. By “metallic”, it is meant that the metallic composition comprises a metallic material, such as a metal, an alloy, an elemental metal, etc. In certain embodiments, the metallic composition comprises at least one of copper, tin, titanium, silver, nickel, aluminum, magnesium, zinc, and alloys thereof (e.g. steel, bronze, etc.).

More typically, as alluded to above, the backing layer 18 is formed from chrome (i.e., the metallic composition comprises chromium), which is described in further detail below. The backing layer 18 may comprise sub-layers (not shown). The backing layer 18 imparts the article 10 with an aesthetic effect, such as imparting a chrome color through the tie-layer 16 and outermost layer 14. If the outermost layer 14 and/or tie-layer 16 are colored or tinted, the article 10 can have various appearances. For example, as introduced above, the article 10 can look pewter in color (i.e., have an aesthetic effect) when the backing layer 18 is chrome and the outermost layer 14 includes some amount of black tinting, e.g. via carbon black pigment as the colorant. Generally, the backing layer 18 is classified as non-polar to very non-polar; however, in certain embodiments, the backing layer 18 can be polar, especially if employing certain metallic materials, such as steel and/or aluminum as the backing layer 18. The backing layer 18 may be classified as being non-reactive (due to, for example, being non-polar), as understood by those skilled in the coatings art. Typically, a surface 22 of the backing layer 18, which is non-polar (also referred to herein as the outermost surface 22 of the backing layer 18), is adhered to the tie-layer 16. It is to be appreciated that the backing layer 18 in its entirety may also be non-polar, and not just the surface 22 thereof. As described above, the tie-layer 16 imparts excellent adhesion strength between the outermost and backing layers 14, 18 when the outermost and backing layers 14, 18 are of different polarity, such as when the outermost layer 14 is polar and the surface 22 of the backing layer 18 is non-polar.

If employed, the substrate layer 20 is generally formed from a flexible material, typically a plastic, more typically a thermoplastic; however, thermosets may also be used, as well as other materials known in the art, such as composites. In certain embodiments, the substrate layer 20 is formed from acrylonitrile butadiene styrene (ABS). Various types and grades of ABS may be employed for making the substrate layer 20. Other suitable plastics, for purposes of the present invention, include, but are not limited to, polycarbonate (PC), ABS/PC, polypropylene (PP), polyethylene (PE), polystyrene (PS), styrene acrylonitrile (SAN), polymethyl methacrylate (PMMA), thermoplastic polyolefin (TPO), TPO/PP, polyamide (PA), ABS/PA, poly(p-phenylene oxide) (PPO), acrylonitrile styrene acrylate (ASA), polyvinyl chloride (PVC), chlorinated PVC (CPVC), alpha methyl styrene acrylonitrile (AMSAN), reaction injected molding (RIM) materials (e.g. RIM polyurethanes), thermoplastic polyurethane (TPU), polyurethane, ethylene propylene diene monomer (EPDM) rubber, elastomers, bulk molding compounds (BMC), sheet molded composites (SMC), acrylic, polyethylene terephthalate (PET), polybutyl-teraphalate (PBT), Noryl®, Xenoy®, and combinations thereof. Plastic materials, for purposes of the present invention, are commercially available from a variety of sources, such as from BASF Corporation, under a variety of trade names depending on type, such as LURAN® (SAN), LURAN® S (ASA), TERLURAN® (ABS), TERBLEND® (ABS/PA), etc. Specific examples of suitable grades of ABS are also commercially available from The Dow Chemical Company, of Midland, Mich., under the trade name MAGNUM®. It is to be appreciated that the substrate layer 20 may be formed from two or more sub-layers of the aforementioned plastic materials (not shown).

To make the article 10, the substrate layer 20 is generally provided, if employed. As described above, the substrate layer 20 may be formed from a plastic, such as ABS. Depending on the use and application of the article 10, the substrate layer 20 may be of various sizes, thickness, and shape. The substrate layer 20 can be formed by any of the processes known in the molding and forming art, for example, and without limitation, by injection molding and reaction injection molding, compression molding, extrusion, and thermoforming techniques.

Next, the backing layer 18 is provided, typically applied to the substrate layer 20, such as by applying the metallic composition to the substrate layer 20 to form the backing layer 18. The backing layer 18 layer may be applied to the substrate layer 20 by various methods known in the art. For example, the backing layer 18 may be molded, extruded, or laminated to the substrate layer 20. In embodiments where the backing layer 18 comprises chromium, chrome may be deposited on the substrate layer 20 by various methods, such as by dipping, molding, and vapor deposition (such as by physical vapor deposition and by chemical vapor deposition). Various methods for depositing chrome on the substrate layer 20 to form the backing layer 18 are disclosed by U.S. Pat. No. 6,277,494 to Mokerji, the disclosure of which is incorporated herewith in its entirety. It is to be appreciated that pre-made parts comprising the substrate and backing layers 18, 20 are also commercially available from a variety of sources, especially those suppliers used for automobile applications.

In certain embodiments, when the backing layer 18 is chrome, the backing layer 18 is built up by successive layers of material, which can be accomplished via a multi-stage dipping process. In other words, a chroming process or “chroming” can be employed to form the backing layer 18. Generally, the chroming process employs chromium thereby forming an outermost chromium layer of the backing layer 18. The chromium layer typically forms oxides on the outermost surface 22 of the backing layer 18, which helps protect lower layers of the chrome. In other embodiments, the backing layer 18 comprises various combinations of two or more sub-layers. In certain embodiments, the backing layer 18 comprises chromium as described and exemplified above, and the substrate layer 20 comprises ABS. Without being bound or limited by any particular theory, it is believed that the surface 22 of the backing layer 18 has some porosity. It is believed that the adhesion promoting composition wets out well over the surface 22 (non-polar), and is drawn into the tiny voids to increase adhesion strength between the tie-layer 16 and the surface 22 of the backing layer 18. Without being bound or limited by any particular theory, it is believed that the backing layer 18 can be at various states, such as an oxidation state (e.g. Cr⁺³, Cr⁺², Cr⁺⁶). It is believed that such oxidation states can increase adhesion strength of the tie-layer 16 on the backing layer 18, depending on the specific components and amounts thereof employed to form the metallic and adhesion promoting compositions. For example, it is believed that electron clouds of the tie-layer 16 can bond with the backing layer 18, which increases adhesion strength there between. In certain embodiments, the backing layer 18 comprises chromium (Cr) at an oxidation state, as exemplified above.

The backing layer 18 may be washed and/or surface treated after formation. In certain embodiments, the backing layer 18 is subjected to several de-ionized water washes to remove any ionization that can be present on the outermost surface 22 of the backing layer 18. In these embodiments, the outermost surface 22 of the backing layer 18 generally remains a non-porous non-polar surface 22 after washing. The backing layer 18 may be surface treated by various methods, in addition or alternative to the washing described above. Surface treating methods are well known and understood by those skilled in the coatings art, and are typically used to alter surface energy of the backing layer 18. Suitable surface treatments may be obtained by various methods including, but not limited to, corona treatment, flame treatment, chemical treatment, etc. In certain embodiments, the corona treatment may include injection of water and/or solvent during surface treatment of the backing layer 18. In certain embodiments, the backing layer 18 is treated to make the outermost surface 22 of the backing layer 18 polar, or to at least increase polarity of the outermost surface 22. In one embodiment, a nitrogen corona is used to treat the outermost surface 22, with injection of a solution having two (2) weight percent N-methylpyrrolidone (NMP) in water into the nitrogen corona during treatment, which increases polarity of the outermost surface 22.

More typically, in certain embodiments, flame treatment and/or corona treatment steps are not employed. These embodiments are useful for reducing manufacturing costs, and it is believed that adhesion strength of the tie-layer 16 to the surface 22 of the backing layer 18 is generally increased if such treatments are excluded from the method of the present invention. In addition, polarity of the backing layer 18 is also unaffected, i.e., remains unchanged/non-polar.

Next, the adhesion promoting composition is typically applied to the backing layer 18 to form the tie-layer 16. The adhesion promoting composition may be applied to the backing layer 18 by various methods known in the coatings art. These methods include, without limitation, spray coating, dip coating, roll coating, curtain coating, and the like. Spraying or spray coating is typically employed for making articles 10 used as automotive parts and trim. Spray coating can be achieved via use of spray guns, spray bells, atomizers, e.g. electrostatic rotating bell (ESRB) atomizers, etc.

Next, the coating composition is typically applied to the tie-layer 16 to form the outermost layer 14. In certain embodiments, the tie-layer 16 is still wet, i.e., either not dried or uncured/not fully cured depending on the composition of the adhesion promoting composition which forms the tie-layer 16, while in other embodiments, the tie-layer 16 is dried/cured. Applying layers “wet-on-wet” or “wet-on-dry/cure” is understood to those skilled in the coatings art. More typically, the tie-layer 16 is tack-free (substantially dry) prior to applying the coating composition, to prevent defects such as sagging. As is understood in the art, reference to tack-free or drying refers to mere flashing off of volatiles (e.g. the solvent(s)), whereas reference to curing refers to both the flashing off of volatiles and also a chemical reaction which occurs between chemical components of a particular composition. The coating composition may be applied to the tie-layer 16 by various methods known in the coatings art. These methods include, without limitation, spray coating, dip coating, roll coating, curtain coating, and the like. Spraying or spray coating is typically employed for making articles 10 used as automotive parts and trim. Spray coating can be achieved via use of spray guns, spray bells, atomizers, e.g. ESRB atomizers, etc. If the outermost layer 14 comprises two or more sub-layers, the sub-layers may be applied on one another “wet-on-wet” or “wet-on-dry/cure”.

The adhesion promoting composition and coating composition (or compositions) can be applied at thicknesses that will produce dry film or cured film thicknesses typical of the coatings art, such as from about 0.01 to about 5.0 mils. Typical thicknesses T1 for the outermost layer 14 can depend on the coating compositions employed. Typical thicknesses for the outermost layer 14, e.g. clearcoat layers 14 or one-layer topcoats 14, are from about 0.5 to about 3.0, more typically from about 1.5 to about 2.5, most typically from about 1.6 to about 2, mils. Typical thicknesses T2 for the tie-layer 16 are from about 0.1 to about 3, more typically from about 0.1 to about 1, yet more typically from about 0.1 to about 0.5, and most typically from about 0.1 to about 0.3, mils. The backing layer 18 and substrate layer 20 are generally of thicknesses T3, T4, common in the art, but may be thicker or thinner, depending on application of the article 10. It is to be appreciated that the substrate layer 20 may not generally have one specific thickness T4, due to configuration, i.e., shape, of the article 10. It is also to be appreciated that thicknesses of each of the layers 14, 16, 18, 20 may be uniform or may vary. In addition, two or more the layers 14, 16, 18, 20 may be of roughly the same thickness, or all of the layers 14, 16, 18, 20 may be of different thicknesses.

The adhesion promoting compositions described herein are commonly dried and the coating compositions described herein are typically thermally cured to form the layers 14, 16 of the article 10. Drying and/or curing temperatures will vary depending on the particular compositions employed, type and amount of the solvent (if employed), etc.; however, these temperatures generally range between about 100° F. and about 270° F. and more typically from about 150° F. to about 230° F. The temperature is generally controlled to prevent warping or deformation of the substrate layer 20 or degradation of one of the other layers 14, 16, 18 during (or after) formation. Drying and/or curing time will vary depending on the particular components and compositions used, and physical parameters such as the thickness T1, T2 of the layers 14, 16; however, typical times range from about 15 to about 60, more typically from about 20 to about 40, and most typically from about 20 to about 30, minutes. Preferred conditions, i.e., the preferred drying and/or curing temperatures and times, depends upon the specific compositions employed and the backing and substrate layers 18, 20, and can be determined by routine experimentation and testing. In one embodiment, the tie- and outermost layers 14, 16 cure in about 25 minutes at a temperature of about 180° F. Various methods may be employed for thermally curing the layers 14, 16, such as use of ovens or other methods known in the coatings art. While methods of making the article 10 have been described and exemplified above, it is to be appreciated that the article 10 may be made by other methods known in the art, and the article 10 of the present invention is not limited to any one particular method of manufacture.

The following examples, illustrating the composite articles of the present invention, are intended to illustrate and not to limit the invention.

### EXAMPLES

Six different composite articles are prepared in triplicate. The six different composite articles (Composite Nos. 1 through 6), are represented in TABLE I below. Composite Nos. 1 and 2 are control composite articles, Composite Nos. 3 and 4 illustrate one embodiment of the present invention, and Composite Nos. 5 and 6 illustrate another embodiment of the present invention.

TABLE I

| Composite No. | 1 | 2 | 3 | 4 | 5 | 6 |
|---|---|---|---|---|---|---|
| Pre-treatment | — | X | — | X | — | X |
| Tie-Layer | — | — | — | — | X | X |
| Clearcoat Layer 1 | X | X | — | — | X | X |
| Clearcoat Layer 2 | — | — | X | X | — | — |

All of the composite articles (Composite Nos. 1 through 6) are prepared using 4″ by 4″ plaques, the plaques are supplied from an automobile trim manufacturer, and include a substrate layer formed from ABS, and a backing layer formed from chrome, which is plated or “chromed” onto the substrate layer. The backing layer (of chrome) comprises a plurality of sub-layers, as described and exemplified above with description of the embodiment of the backing layer including a layer of chromium.

The plaques of Composite Nos. 2, 4, and 6 are washed via de-ionized water washing and are surface treated via a nitrogen corona treatment employing injection of a solution having two (2) weight percent N-methylpyrrolidone (NMP) in water during treatment. The plaques of Composite Nos. 1, 3, and 5 are washed but are not pre-treated, i.e., no flame or corona treatment is employed. As such, surfaces of Composite Nos. 1, 3, and 5 are generally non-polar, whereas surfaces of Composite Nos. 2, 4, and 6 are generally polar due to the surface treatment.

Composite Nos. 1, 2, 5, and 6 include a first paint layer (Clearcoat Layer 1), disposed on the backing layer. Clearcoat Layer 1 is formed from a flexible 2K urethane/acrylic clearcoat paint composition, commercially available from BASF Corporation of Florham Park, N.J.

Composite Nos. 5 and 6 further include a tie-layer (Tie-Layer) disposed between the backing layer and Clearcoat Layer 1. Tie-Layer is formed from an adhesion promoting composition comprising about 15 parts by weight of a CPO as a halogenated polyolefin, about 83 parts by weight Aromatic 100 as a solvent, and about 2 parts by weight butyl cellosolve as a solvent. The CPO is modified with maleic anhydride and is commercially available from Toyo Kasei Kogyo Co., Ltd., of Osaka, Japan, under the trade name HARDLEN®. Aromatic 100 is commercially available from Exxon Mobil Corporation of Irving, Tex. Butyl cellosolve is commercially available from a variety of sources.

Composite Nos. 3 and 4 include a first paint layer (Clearcoat Layer 2), disposed on the backing layer. Clearcoat Layer 2 is formed from 40 parts by weight of the adhesion promoting composition used to form Tie-Layer and 280 parts by weight of the 2K urethane/acrylic clearcoat paint composition used to form Clearcoat Layer 1.

All of the composite articles (Composite Nos. 1 through 6) include a second paint layer disposed on the respective first layers, the second paint layer is formed from the same paint composition as Clearcoat Layer 1.

The plaques are sprayed off-line with the paint and adhesion promoting compositions, and then placed on-line to go through a normal flash/bake cycle used in the coating art. The flash/bake cycle occurs in an oven at various temperatures, such as at about 180° F. Optimum temperature and time requirements for flashing and curing of the Tie- and Clearcoat Layers are found through routine experimentation.

Adhesion strength of the composite articles is tested. To test adhesion strength of the composite articles, 10-day humidity and adhesion testing according to GM4465P is performed, with cross-hatching scratches being cut into the layers to simulate damage to the composite articles. To further test adhesion strength of the composite articles, thermal shock testing according to GM9525P is performed, with the composite articles being scratched in a cross-hatch to simulate damage to the composite articles. Initial tape adhesion strength of the composites articles is performed according to GM9071P, Method B. Weatherometer (WOM) testing of the composite articles is performed according to J-1960 employing BORO BORO Filters.

Upon visual inspection of the composite articles after 10-day humidity and adhesion testing, Composite Nos. 1 and 2 have many medium blisters and roughly 0% adhesion (e.g. at the cross-hatching, Clearcoat Layer 1 completely delaminates from the backing layer). Composite Nos. 3 and 4 have many micro-blisters and roughly 0% adhesion (e.g. at the cross-hatching, Clearcoat Layer 2 completely delaminates from the backing layer). Composite Nos. 5 and 6 have very little to zero micro-blisters and 100% adhesion (e.g. at the cross-hatching, Clearcoat Layer 1 and Tie-Layer completely adheres to the backing layer). Upon visual inspection of the composite articles after thermal shock testing, Composite Nos. 1 and 2 have adhesion failure (e.g. Clearcoat Layer 1 substantially delaminates from the backing layer). Composite Nos. 3 and 4 have adhesion failure (e.g. Clearcoat Layer 2 substantially delaminates from the backing layer). Composite Nos. 5 and 6 have zero to very slight adhesion failure. In sum, Composite Nos. 5 and 6 show dramatically improved adhesion performance in thermal shock and humidity testing relative to Composite Nos. 1 through 4, which are typically described by the plaque supplier as critical failure modes. TABLE II below illustrates physical testing data between Composites Nos. 1 and 5. As illustrated, Composite No. 5 has excellent adhesion properties relative to Composite No. 1, especially under humidity testing conditions.

TABLE II

| Composite No. | 1 | | 5 |
|---|---|---|---|
| Initial Tape Adhesion | 100% | Adhesion | 100% Adhesion |
| 10 Day Humidity Testing + | 0% | Adhesion | 100% Adhesion |
| Tape Adhesion | | | |
| Thermal Shock Testing | 25% | Adhesion | 99% Adhesion |
| WOM Testing | 95% | Adhesion | 100% Adhesion |

Three additional composite articles are prepared in triplicate. The three composite articles (Composite Nos. 7 through 9), are represented in TABLE III below. Composite No. 7 is a control composite article, Composite No. 8 illustrates one embodiment of the present invention, and Composite No. 9 illustrates another embodiment of the present invention.

TABLE III

| Composite No. | 7 | 8 | 9 |
|---|---|---|---|
| Pre-treatment | X | X | — |
| Tie-Layer | — | X | X |
| Clearcoat Layer 3 | X | — | — |
| Clearcoat Layer 4 | — | X | X |

All of the composite articles (Composite Nos. 7 through 9) are prepared using 4″ by 4″ plaques, the plaques are supplied from an automobile trim manufacturer, and include a substrate layer formed from ABS, and a backing layer formed from chrome, which is plated or “chromed” onto the substrate layer. The backing layer (of chrome) comprises a plurality of sub-layers, as described and exemplified above.

All of the plaques of Composite Nos. 7 through 9 are washed via de-ionized water washing. The plaques of Composite Nos. 7 and 8 include a nitrogen corona treatment employing injection of a solution having two (2) weight percent N-methylpyrrolidone (NMP) in water during treatment, thereby increasing polarity of their surfaces. The plaques of Composite No. 9 are not nitrogen corona treated, thereby leaving their surfaces unaffected, i.e., leaving them non-polar.

Composite No. 7 includes a first paint layer (Clearcoat Layer 3), disposed on the backing layer. Clearcoat Layer 3 is formed from a flexible 2K urethane/acrylic clearcoat paint composition, commercially available from Red Spot Paint & Varnish Company, of Evansville, Ind. Clearcoat Layer 3 includes carbon black tinting.

Composite Nos. 8 and 9 further include a tie-layer (Tie-layer) disposed between the backing layer and Clearcoat Layer 1. Tie-Layer is the same as described above.

Composite Nos. 8 and 9 include a first paint layer (Clearcoat Layer 4), disposed on Tie-Layer. Clearcoat Layer 4 is formed from the 2K urethane/acrylic clearcoat paint composition of the Clearcoat Layer 1, and includes about 0.01 wt % carbon black pigment for tinting of Clearcoat Layer 4.

All of the composite articles (Composite Nos. 7 through 9) include a second paint layer disposed on the respective first layers, the second paint layer is formed from the same paint composition as the respective Clearcoat Layers 3 and 4.

The plaques are sprayed off-line with the paint and adhesion promoting compositions, and then placed on-line to go through a normal flash/bake cycle used in the coating art. The flash/bake cycle occurs in an oven at various temperatures, such as at about 180° F. Optimum temperature and time requirements for flashing and curing of the Tie- and Clearcoat Layers are found through routine experimentation.

Adhesion strength of the composite articles is tested. To test adhesion strength of the composite articles, 10-day humidity and adhesion testing according to GM4465P is performed, with cross-hatching scratches being cut into the layers to simulate damage to the composite articles. To further test adhesion strength of the composite articles, thermal shock testing according to GM9525P is performed, with the composite articles being scratched in a cross-hatch to simulate damage to the composite articles. TABLE IV below illustrates physical testing data between Composites Nos. 7 through 9. QUV testing, or accelerated WOM testing, is performed according to J-2020.

TABLE IV

| Composite No. | 7 | 8 | 9 |
|---|---|---|---|
| WOM Testing | | | |
| 500 Hrs; Adhesion Loss | 4% | 0% | 0% |
| 1000 Hrs; Adhesion Loss | 1% | 0.5% | 0% |
| QUV Testing | | | |
| 500 Hrs; Adhesion Loss | 2% | 0.5% | 0% |
| 1000 Hrs; Adhesion Loss | 1% | 0% | 0% |

After 500 hours WOM and QUV testing, adhesion is good, gloss is good, and appearance is good, upon visual inspection. Color drift is not detectable visually, and slight lightening of Composite Nos. 7 through 9 is detected using a colorimeter. To further test adhesion strength of the composite articles, thermal shock testing according to GM9525P is performed, with the composite articles being scratched in a cross-hatch to simulate damage to the composite articles. Upon visual inspection, Composite 7 has heavy delamination, e.g. greater than 50%, and Composite Articles 8 and 9 both have slight delamination, e.g. less than 5%.

The present invention has been described herein in an illustrative manner, and it is to be understood that the terminology which has been used is intended to be in the nature of words of description rather than of limitation. Many modifications and variations of the present invention are possible in light of the above teachings. The invention may be practiced otherwise than as specifically described within the scope of the appended claims.

1. A composite article comprising:
a substantially transparent outermost layer formed from a clearcoat coating composition;
a backing layer disposed adjacent said substantially transparent outermost layer and formed from a metallic composition for imparting said composite article with an aesthetic effect; and
a tie-layer disposed between said substantially transparent outermost layer and said backing layer, said tie-layer formed from an adhesion promoting composition comprising a halogenated polyolefin for adhering said substantially transparent outermost layer and said backing layer;
wherein said clearcoat coating composition is selected from the group of acrylic paint compositions, urethane paint compositions, urethane/acrylic paint compositions, carbamate paint compositions, melamine paint compositions, polyester paint compositions, and combinations thereof.

2. A composite article as set forth in claim 1 wherein said metallic composition comprises chromium.

3. A composite article as set forth in claim 1 wherein said metallic composition comprises at least one of copper, tin, titanium, silver, nickel, aluminum, magnesium, zinc, and alloys thereof.

4. A composite article as set forth in claim 1 wherein said halogenated polyolefin is a chlorinated polyolefin.

5. A composite article as set forth in claim 4 wherein said chlorinated polyolefin is modified with maleic anhydride

6. A composite article as set forth in claim 4 wherein said chlorinated polyolefin has a chlorine content of from about 3 to about 35 weight % based on 100 parts by weight of said chlorinated polyolefin.

7. A composite article as set forth in claim 1 wherein said backing layer includes a surface which is non-polar and adhered to said tie-layer.

8. A composite article as set forth in claim 1 wherein said substantially transparent outermost layer is polar.

9. A composite article as set forth in claim 1 wherein said adhesion promoting composition is non-polar.

10. A composite article as set forth in claim 1 wherein said clearcoat coating composition is a urethane/acrylic paint composition.

11. A composite article as set forth in claim 1 wherein said substantially transparent outermost layer further comprises a colorant for further imparting said composite article with the aesthetic effect.

12. A composite article as set forth in claim 1 wherein said tie-layer is substantially transparent and has a thickness of from about 0.1 to about 1 mils.

13. A composite article as set forth in claim 1 wherein said substantially transparent outermost layer has a thickness of from about 0.5 to about 3.0 mils.

14. A composite article as set forth in claim 1 further comprising a substrate layer disposed opposite said substantially transparent outermost layer and adhered to said backing layer, said substrate layer is selected from the group of thermoplastics, thermosets, and combinations thereof.

15. A composite article as set forth in claim 1 further comprising a substrate layer disposed opposite said substantially transparent outermost layer and adhered to said backing layer, said substrate layer is selected from the group of acrylonitrile butadiene styrene (ABS), thermoplastic olefin (TPO), polypropylene (PP), and combinations thereof.

16. A composite article as set forth in claim 1 wherein said tie-layer is in direct contact with both of said substantially transparent outermost and said backing layers.

17. A method of forming the composite article as set forth in claim 1.
